(19) United States
(12) Patent Application Publication
(10) Pub. No.: US 2012/0246092 A1
(43) Pub. Date: Sep. 27, 2012

(54) Credibility Scoring and Reporting

(76) Inventors: Aaron Stibel, Malibu, CA (US); Jeffrey M. Stibel, Malibu, CA (US); Jeremy Loeb, Santa Monica, CA (US); Judith Gentile Hackett, Melibu, CA (US); Moujan Kazerani, Santa Monica, CA (US)

(21) Appl. No.: 13/071,434

(22) Filed: Mar. 24, 2011

(51) Int. Cl. G06Q 30/00

(52) U.S. Cl. 705/347

(57) ABSTRACT

Some embodiments provide methods, systems, and computer software products for producing a tangible asset in the form of a standardized score that quantifiably measures business credibility based on a variety of data sources and credibility data that includes quantitative data and qualitative data. Some embodiments produce a separate tangible asset in the form of a report from which each business can identify practices that have been successful, practices that have inhibited the success of the business, desired improvements by customers, where future growth opportunities lie, and changes that can be made to improve the future growth and success of the business and thereby improve on the credibility score of the business.

### TECHNICAL FIELD

The present invention pertains to systems, methods, and processes for enabling businesses to determine, communicate, and manage their credibility.

### BACKGROUND

Creditworthiness of individuals and businesses has long been a quantifiable measure from which many personal and commercial transactions are based. The creditworthiness of an individual is used to determine terms (e.g., amounts and interest rates) when individuals seek home mortgage loans, personal loans, property rental, and credit cards. Several credit agencies exist and operate to determine an individual's creditworthiness and to sell that information to interested buyers. Credit agencies derive the creditworthiness of individuals by monitoring individual spending habits, payment habits, net worth, etc. Credit agencies convert these and other monitored behaviors into a quantifiable credit score that has been standardized to range between 300-850 points, with a higher score representing greater creditworthiness and a lower score representing lesser creditworthiness.

Business creditworthiness is also a quantifiable measure that drives many business transactions. However, deriving business creditworthiness a fundamentally more complex problem than deriving an individual's creditworthiness. For individuals, there is a one-to-one correspondence between an identifier (i.e., social security number) and the individual. Such is not the case for many businesses. A business may operate under different names, subsidiaries, branches, and franchises as some examples. Moreover, tracking business assets, accounts, and transactions is further complicated because businesses merge, go out of business, start anew, split, etc. Accordingly, more resources are needed to monitor and analyze business creditworthiness. Companies, such as Dun & Bradstreet, operate to monitor and derive the creditworthiness of businesses. Business credit reports can be purchased from Dun & Bradstreet and other such business credit reporting companies. Sales of such information has become a multi-billion dollar industry.

While critical to some small business needs, business creditworthiness is often immaterial to determining the day-to-day success of the small business. For instance, whether a client leaves satisfied with a service or a product that has been purchased from the small business is instrumental in determining whether that client will be a repeat customer or will provide referrals to encourage others to visit the small business. A sufficient number of good client experiences beneficially increases the exposure of the small business, thereby resulting in better chances of growth, success, and profitability. Conversely, a sufficient number of bad client experiences can doom a small business. The success of the small business is therefore predicated more on generated good will and good reputation than it is on business creditworthiness. Good will, reputation, satisfaction, and other such criteria that impact the small business operations on a day-to-day basis are hereinafter referred to as credibility.

There is currently no service from which small businesses can accurately and readily ascertain their credibility. Some small businesses conduct surveys. Other small businesses look to various mediums to piece together their credibility. These mediums include newspaper and magazine reviews, client reviews that are posted on internet websites such as www.yelp.com and www.citysearch.com, and complaints logged via telephone to the Better Business Bureau as some examples. It is very time consuming, inaccurate, and difficult for the small business to piece together its credibility in this manner. Small businesses are therefore unable to understand or appreciate the factors affecting their credibility and, as a result, are unable to address the problems directly.

Accordingly, there is need to monitor the credibility of businesses across multiple sources and mediums and to provide an accurate account of the business credibility. There is further a need to quantify the credibility information to provide an easy-to-understand and readily available view of the creditability of the business such that credibility can be identified without having to read through multiple textual reviews and comments. There is also a need for the credibility to be standardized across all businesses such that credibility is derived without being subject to biases or inconsistent interpretation of credibility data. Furthermore, there is a need to provide tools, resources, and information from which the business can improve upon its credibility.

### SUMMARY OF THE INVENTION

It is an object of the present invention to define methods, systems, and computer software products for generating a tangible asset in the form of a standardized score that quantifiably measures business credibility based on a variety of data sources and credibility data that includes quantitative data and qualitative data. It is further an object to utilize the credibility score in conjunction with the credibility data to provide a separate tangible asset in the form of a report from which each business can identify practices that have been successful, practices that have inhibited the success of the business, desired improvements by customers, where future growth opportunities lie, and changes that can be made to improve the future growth and success of the business and thereby improve on the credibility score of the business.

Accordingly, some embodiments provide a credibility scoring and reporting system and methods. The credibility scoring and reporting system includes a master data manager, database, reporting engine, and interface portal. The master data manager aggregates qualitative and quantifiable credibility data from multiple data sources and the aggregated data is matched to an appropriate business entity to which the data relates. The reporting engine performs natural language processing over the qualitative credibility data to convert the qualitative credibility data into numerical measures that quantifiably represent the qualitative credibility data. The quantitative measures and credibility data are then filtered to remove abnormalities, adjust weighting where desired, and to normalize the quantitative measures. For a particular business entity, the reporting engine compiles the quantitative measures that relate to the particular business entity into a credibility score. In some embodiments, a credibility report is generated to detail the derivation of the credibility score with relevant credibility data. In some embodiments, the credibility report also suggests actions for how the business can improve upon its credibility score. Using the interface portal, businesses and individuals can purchase and view the credibility scores and/or credibility reports while also engaging and interacting with the credibility scoring and reporting system. Specifically, users can submit credibility data and correct mismatches between credibility data and incorrect business entities.

### BRIEF DESCRIPTION OF THE DRAWINGS

In order to achieve a better understanding of the nature of the present invention a preferred embodiment of the credibility scoring and reporting system and methods will now be described, by way of example only, with reference to the accompanying drawings in which:

FIG. 1 presents a process performed by the credibility scoring and reporting system to generate a credibility score and credibility report in accordance with some embodiments.

FIG. 2 presents some components of the credibility scoring and reporting system of some embodiments.

FIG. 3 illustrates components of the master data manager in accordance with some embodiments.

FIG. 4 presents a flow diagram for the matching process that is performed by the master data manager of some embodiments.

FIG. 5 illustrates an exemplary data structure for storing the credibility scoring information.

FIG. 6 illustrates some components of the reporting engine for generating credibility scores and credibility reports in accordance with some embodiments.

FIG. 7 presents a process performed by the NLP engine for identifying relationships between textual quantifiers and modified objects in accordance with some embodiments.

FIG. 8 illustrates identifying textual quantifier and modified object pairs in accordance with some embodiments.

FIG. 9 presents a process for deriving quantitative measures from qualitative credibility data in accordance with some embodiments.

FIG. 10 illustrates mapping identified textual quantifier and modified object pairs to a particular value in a scale of values in accordance with some embodiments.

FIG. 11 presents a process performed by the scoring filters to filter the quantitative measures and credibility data in accordance with some embodiments.

FIG. 12 illustrates a credibility report window within the interface portal in accordance with some embodiments.

FIG. 13 presents an alternative credibility report viewer in accordance with some embodiments.

FIG. 14 illustrates a computer system with which some embodiments are implemented.

### DETAILED DESCRIPTION OF THE INVENTION

In the following detailed description, numerous details, examples, and embodiments of a credibility scoring and reporting system and methods are set forth and described. As one skilled in the art would understand in light of the present description, the system and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

I. Overview

For the small business, business credibility is an invaluable asset that can be used to identify which business practices have been successful, practices that have inhibited the success of the business, desired improvements by customers, where future growth opportunities lie, and changes that can be made to improve the future growth and success of the business. Today, business credibility exists as qualitative data and as non-standardized quantitative measures that selectively gauge various factors relating to a business using different ranking systems. However, the qualitative and non-standardized nature of credibility data results in an intangible asset for which baseline measurements do not exist, cross-comparisons cannot be made, and against which individual biases and scarcity of information undermine the relevancy of the information. Consequently, businesses, especially small business, are unable to effectively determine or evaluate their credibility in the marketplace and future strategic decisions are misguided as a result.

To overcome these and other issues and to provide a tangible asset that quantifiably measures business credibility, some embodiments provide a credibility scoring and reporting system. The credibility scoring and reporting system generates standardized credibility scores that quantifiably measure business credibility based on aggregated data from multiple data sources and that present the credibility as a readily identifiable score that can be comparatively analyzed against credibility scores of competitors derived using the same system and methods. In some embodiments, the credibility scoring and reporting system generates credibility reports that detail the derivation of the credibility score for each business. More specifically, the credibility report is a single tool from which a particular business can identify business practices that have been successful, practices that have inhibited the success of the business, desired improvements by customers, where future growth opportunities lie, and changes that can be made to improve the future growth and success of the business.

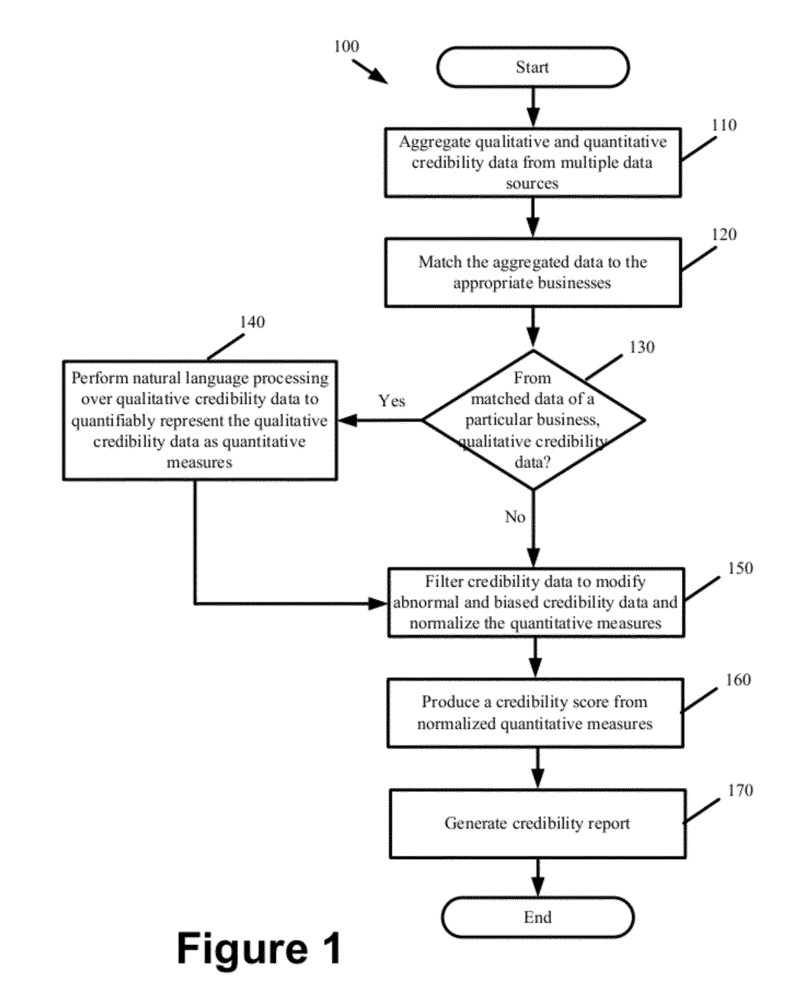

FIG. 1 presents a process 100 performed by the credibility scoring and reporting system to generate a credibility score and credibility report in accordance with some embodiments. The process begins by aggregating (at 110) qualitative and quantitative credibility data from multiple data sources. This includes collecting data from various online and offline data sources through partner feeds, files, and manual inputs. The process matches (at 120) the aggregated data to the appropriate businesses. The matched data for each business is analyzed (at 130) to identify qualitative credibility data from quantitative credibility data. The process performs natural language processing (at 140) over the qualitative credibility data to convert the qualitative credibility data into quantitative measures. The derived quantifiable measures for the qualitative credibility data and the other aggregated quantitative credibility data are then subjected to the scoring filters that modify (at 150) quantitative measures for abnormal and biased credibility data and that normalize the quantitative measures. The process produces (at 160) a credibility score by compiling the remaining normalized quantitative measures.

The credibility score accurately represents the credibility of a given business, because (i) the credibility score is computed using data from varied data sources and is thus not dependent on or disproportionately affected by any single data source, (ii) the credibility data is processed using algorithms that eliminate individual biases from the interpretation of the qualitative credibility data, (iii) the credibility data is processed using filters that eliminate biased credibility data while normalizing different quantitative measures, and (iv) by using the same methods and a consistent set of algorithms to produce the credibility score for a plurality of businesses, the produced credibility scores are standardized and can be subjected to comparative analysis in order to determine how the credibility score of one business ranks relative to the credibility scores of other competitors or businesses. As a result, the credibility score can be sold as a tangible asset to those businesses interested in understanding their own credibility.

In some embodiments, the process also generates (at 170) a credibility report as a separate tangible asset for businesses interested in understanding the derivation of their credibility score and how to improve their credibility score. In some embodiments, the credibility report presents relevant credibility data to identify the derivation of the credibility score. In some embodiments, the credibility report also suggests actions for how the business can improve upon its credibility score.

Some embodiments provide an interface portal from which businesses and individuals can purchase and view the credibility scores and/or credibility reports. Using these assets (i.e., credibility scores and credibility reports), businesses can formulate accurate and targeted business objectives to improve their credibility and, more importantly, their likelihood for future growth and success. Individuals and businesses will also have access to the credibility scores of other businesses. The credibility score can be used in this manner to guide clientele to credible businesses and steer clientele away from businesses providing a poor customer experience. Moreover, the credibility scores can serve to identify businesses with which a particular business would want to partner with or form relationships with for future business transactions. Accordingly, there is incentive for businesses to improve upon their credibility scores as clientele and partners may be looking at the same information when determining whether or not to conduct business with a particular business.

The portal further acts as a means by which businesses can be directly involved with the credibility scoring process. Specifically, using the interface portal, business can submit pertinent credibility data that may otherwise be unavailable from the data sources and correct mismatched credibility data.

II. Credibility Scoring and Reporting System

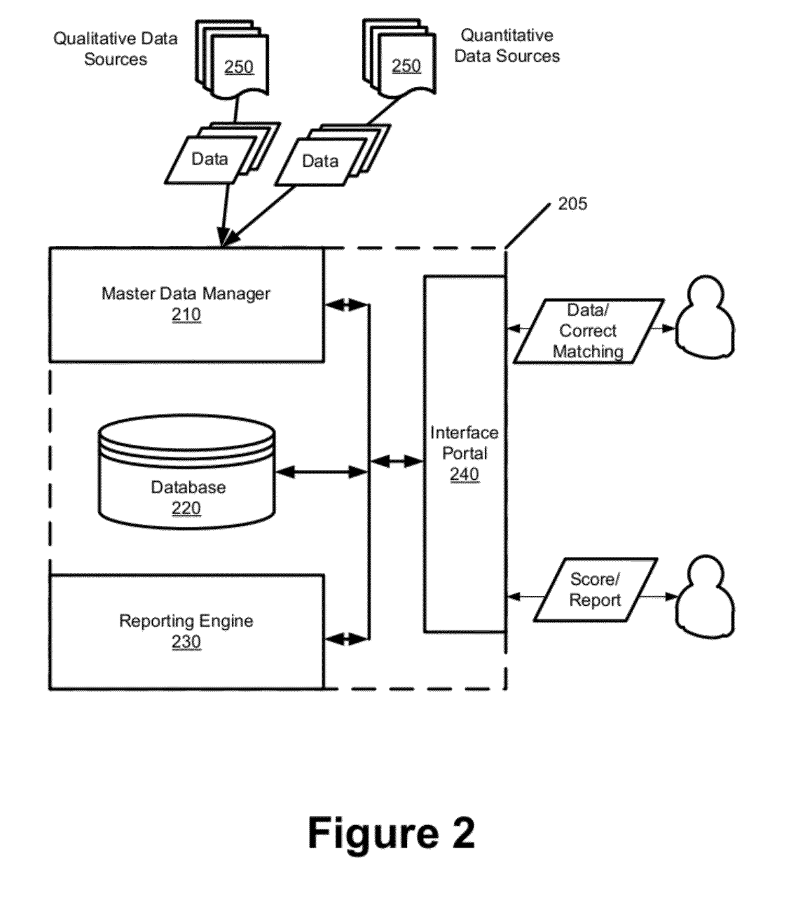

FIG. 2 presents components of the credibility scoring and reporting system 205 of some embodiments. The credibility scoring and reporting system 205 includes (1) master data manager 210, (2) database 220, (3) reporting engine 230, and (4) interface portal 240. As one skilled in the art would understand in light of the present description, the credibility scoring and reporting system 205 may include other components in addition to or instead of the enumerated components of FIG. 2. The components 210-240 of FIG. 2 are not intended as an exhaustive listing, but rather as an exemplary set of components for descriptive and presentation purposes. The overall system 205 is designed with modular plug-in components whereby new components or enhanced functionality can be incorporated within the overall system 205 without having to modify existing components or functionality.

A. Master Data Manager

At present, a business can attempt to determine its credibility by analyzing credibility data at a particular data sources to see what others are saying about the business. Credibility obtained in this manner is deficient in many regards. Firstly, credibility that is derived from one or a few data sources is deficient because a sufficient sampling of credibility cannot be obtained from such few data sources. For example, a site that includes only two negative reviews about a particular business does not accurately portray the credibility of that particular business when that particular business services thousands of individuals daily. Moreover, one or more of the data sources may have biased data or outdated data that disproportionately impact the credibility of the business. Secondly, credibility that is derived from one or a few data sources is deficient because each data source may contain information as to a particular aspect of the business. As such, credibility derived from such few sources will not take into account the entirety of the business and can thus be misleading. Thirdly, credibility is deficient when it is not comparatively applied across all businesses, amongst competitors, or a particular field of business. For example, a critical reviewer may identify a first business as “poor performing” and identify a second business as “horribly performing”. When viewed separately, each business would be classified with poor credibility. However, with comparative analysis, the first business can be classified with better credibility than the second business. Fourthly, credibility data from different reviewers or data sources is not standardized which opens the credibility data to different interpretations and individual biases. For example, it is difficult to determine whether for the same business a 3 out of 5 ranking from www.yelp.com is equivalent to a 26 out of 30 ranking on www.zagat.com. Similarly, a review that states the services of a first business as “good” can be interpreted by the first business as a successful or positive review, whereas the same review of “good” for a second business can be interpreted by the second business as an average review from which services have to be improved upon.

To address these and other issues in deriving business credibility, some embodiments provide the master data manager 210 to interface with multiple data sources 250 and to automatedly acquire relevant credibility data from these sources 250 at regular and continuous intervals. In so doing, the master data manager 210 removes the deficiencies that result from an insufficient sample size, outdated data, and lack of comparative data.

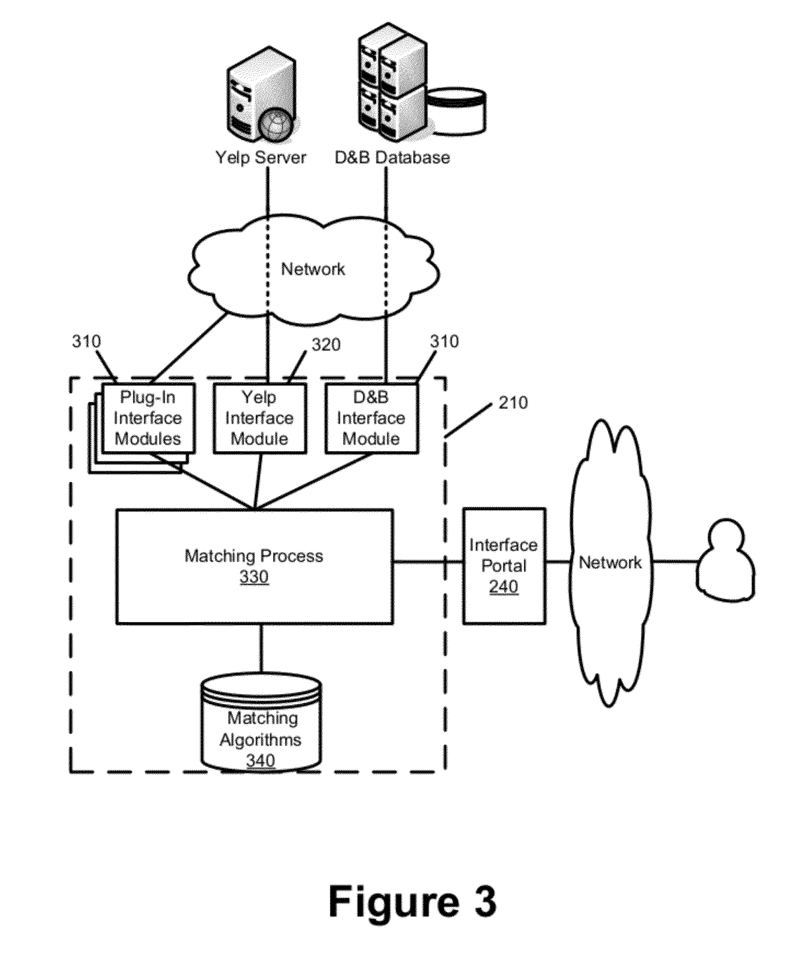

FIG. 3 illustrates components of the master data manager 210 in accordance with some embodiments. The master data manager 210 includes various plug-in interface modules 310 (including plug-in 320), matching process 330, and database storing a set of matching algorithms 340. Access to the master data manager 210 is provided through the interface portal 240 of FIG. 2.

The master data manager 210 aggregates data from various data sources through the plug-in interface modules 310 (including 320) and through the interface portal 240. Each plug-in interface module 310 is configured to automatically interface with one or more data sources in order to extract credibility data from those data sources. In some embodiments, each plug-in interface module 310 is configured with communication protocols, scripts, and account information to access one or more data sources. Additionally, each plug-in interface module 310 may be configured with data crawling functionality to extract credibility data from one or more data sources. A particular plug-in interface module navigates through a particular data source in order to locate the credibility data. In one illustrated example, the master data manager 210 includes a particular plug-in interface module 320 to the website www.yelp.com. This interface module 320 can be configured with account information to access the www.yelp.com website and a data crawler script to scan through and extract business creditability data directly from the website. In some embodiments, partnership agreements are established with the data sources, whereby the plug-in interface modules directly interface with one or more databases of the data source in order to extract the credibility data.

The extracted credibility data includes qualitative data and quantitative data about one or more businesses. Qualitative data includes customer and professional review data, blog content, and social media content as some examples. Some data sources from which qualitative data about various businesses may be acquired are internet websites such as www.yelp.com, www.citysearch.com, www.zagat.com, www.gayot.com, www.facebook.com, and www.twitter.com. Accordingly, some embodiments of the master data manager 210 include a different plug-in interface module 310 to extract the credibility data from each of those sites. Quantitative data includes business credit, other business information (e.g., address, phone number, website, etc.), and credibility data that is quantitatively measured using some scale, ranking, or rating. Some quantitative data sources include Dun & Bradstreet and the Better Business Bureau (BBB). Some qualitative data sources may also include quantitative credibility data. For example, www.yelp.com includes qualitative data in the form of textual reviews and comments and quantitative data in the form of a 0 out of 5 rating system. Some embodiments of the master data manager 210 include a different plug-in interface module 310 to extract quantitative data from the quantitative data sources.

The plug-in interface modules 310 allow data from new data sources to be integrated into the master data manager 210 without altering functionality for any other plug-in interface modules 310. This modularity allows the system to scale when additional or newer data sources are desired. Moreover, the plug-in interface modules 310 allow the credibility data to automatically and continuously be acquired from these various data sources. In some embodiments, the aggregated data includes copied text, files, feeds, database records, and other digital content.

Qualitative data and quantitative data may also be aggregated from other mediums including print publications (e.g., newspaper or magazine articles), televised commentary, or radio commentary. In some embodiments, the data sources access the interface portal 240 in order to provide their data directly to the master data manager 210. For example, relevant magazine articles may be uploaded or scanned and submitted through the interface portal 240 by the publisher. Publications and recordings may also be submitted by mail. An incentive for the publisher to submit such information is that doing so may increase the exposure of the publisher. Specifically, the exposure may increase when submitted publications are included within the generated credibility reports of some embodiments.

Credibility data may also be submitted directly by the business to the master data manager 210. This is beneficial to small businesses that are unknown to or otherwise ignored by the various data sources. Specifically, credibility data can be submitted through the interface portal 240 by the business owner and that data can be incorporated into the credibility scores and credibility reports as soon as the data becomes available. In this manner, the business can be directly involved with the credibility data aggregation process and need not depend on other data sources to provide credibility data about the business to the master data manager 210. For example, the Los Angeles County of Health issues health ratings to restaurants on a graded A, B, and C rating system. Should a restaurant receive a new rating, the restaurant business owner can submit the new rating to the master data manager 210 through the interface portal 240 without waiting for a third party data source to do so. A submission may be made via a webpage in which the submitting party identifies himself/herself and enters the data as text or submits the data as files.

The master data manager 210 tags data that is aggregated using the plug-in modules 310 and data that is submitted through the interface portal 240 with one or more identifiers that identify the business to which the data relates. In some embodiments, the identifiers include one or more of a name, phonetic name, address, unique identifier, phone number, email address, and Uniform Resource Locator (URL) as some examples. For automatically aggregated credibility data, the plug-in modules 310 tag the aggregated credibility data with whatever available identifiers are associated with the credibility data at the data source. For example, the www.yelp.com site groups reviews and ranking (i.e., credibility data) for a particular business on a page that includes contact information about the business (e.g., name, address, telephone number, website, etc.). For credibility data that is submitted through the interface portal 240, the submitting party will first be required to create a user account that includes various identifiers that are to be tagged with the credibility data that is sent by that party.

In some cases, the tagged identifiers do not uniquely or correctly identify the business that the data is to be associated with. This may occur when a business operates under multiple different names, phone numbers, addresses, URLs, etc. Accordingly, the master data manager 210 includes matching process 330 that matches the aggregated data to an appropriate business using a set of matching algorithms from the matching algorithms database 340. To further ensure the integrity and quality of the data matching, some embodiments allow for the business owners and community to be involved in the matching process 330.

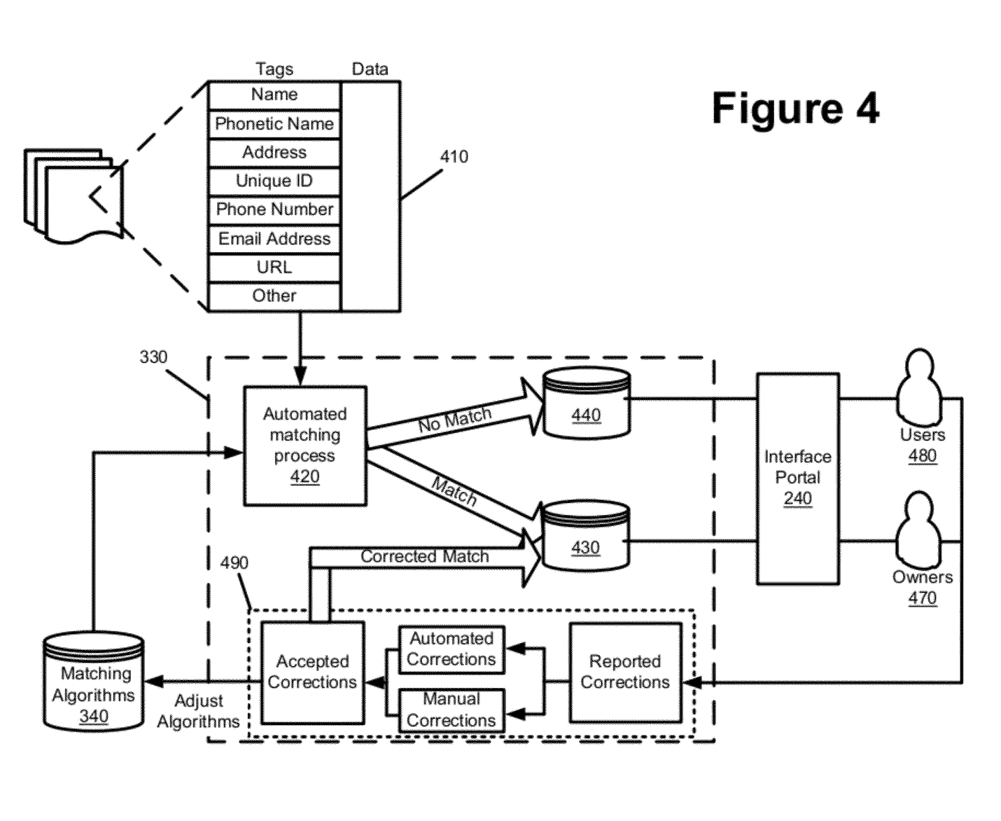

FIG. 4 presents a flow diagram for the matching process 330 that is performed by the master data manager of some embodiments. The matching process 330 involves tagged credibility data 410, an automated matching process 420, a first database 430, a second database 440, interface portal 240, owners 470, user community 480, correction process 490, and matching algorithms database 340.

The matching process 330 begins when tagged credibility data 410 is passed to the automated matching process 420. The automated matching process 420 uses various matching algorithms from the matching algorithms database 340 to match the credibility data 410 with an appropriate business. Specifically, the credibility data 410 is associated with an identifier that uniquely identifies the appropriate business. When a match is made, the credibility data is stored to the first database 430 using the unique identifier of the business to which the credibility data is matched. In some embodiments, the first database 430 is the database 220 of FIG. 2. In some embodiments, the unique identifier is referred to as a credibility identifier. As will be described below, the credibility identifier may be one or more numeric or alphanumeric values that identify the business.

In addition to matching the data to the appropriate business, the automated matching process 420 may also perform name standardization and verification, address standardization and verification, phonetic name matching, configurable matching weights, and multi-pass error suspense reduction. In some embodiments, the automated matching process 420 executes other matching algorithms that match multiple business listings to each other if ownership, partnership, or other relationships are suspected. For example, the automated matching process 420 determines whether the Acme Store in New York is the same business as the Acme Store in Philadelphia, whether variations in the spelling of the word Acme (e.g., “Acme”, “Acmi”, “Akme”, “Ackme”, etc.) relates to the same business or different businesses, or whether “Acme Store”, “Acme Corporation”, and “Acme Inc.” relate to the same business or different businesses. Such matching is of particular importance when ascertaining credibility for businesses with both a digital presence (i.e., online presence) and an actual presence. For instance, offline credit data may be associated with a business entity with the name of “Acme Corporation” and that same business may have online credibility data that is associated with the name of “Acme Pizza Shop”.

However, the matching process 330 may be unable to automatically match some of the credibility data to a business when there is insufficient information within the tags to find an accurate or suitable match. Unmatched credibility data is stored to the second database 440. The second database 440 is a temporary storage area that suspends unmatched credibility data until the data is discarded, manually matched by owners 470, or manually matched by users in the community 480.

The interface portal 240 of FIG. 2 allows business owners 470 and a community of users 480 to become involved in the matching process 330. In some embodiments, the interface portal 240 is a website through which business owners 470 gain access to the matching process 330 and the databases 430 and 440. Through the interface portal 240, business owners 470 can claim their accounts and thereafter control matching errors, detect identity fraud, and monitor the integrity of their credibility score. Specifically, owners 470 can identify matching errors in the first database 430 and confirm, decline, or suggest matches for credibility data that has been suspended to the second database 440. Through the interface portal 240, business owners 470 can address credibility issues in real-time. In some embodiments, business owners 470 include agents or representatives of the business that are permitted access to the business owner account in the credibility scoring and reporting system.

In some embodiments, the interface portal 240 also provides users access to the matching process 330 through a plug-in. The plug-in can be utilized on any website where business credibility data is found. In some embodiments, the plug-in is for external websites that wish to seamlessly integrate the backend of credibility data suppliers to the credibility scoring and reporting system. In this manner, a business can own and manage the review of credibility data itself and the website for that business utilizes the plug-in as its business review provider. This facilitates creation of a single source of credibility across all participating third party websites. Accordingly, whenever a user in the community 480 or business owner 470 spots an incorrect match or issues with credibility data, they can interact with that data through the plug-in. This allows for community 480 interaction whereby other users help improve matching results. In so doing, business review data is transformed into interactive connections of owners and users in the community.

When an improper match is flagged for review or a new match is suggested, it is passed to the correction process 490 for verification. In some embodiments, the correction process 490 includes automated correction verification and manual correction verification. Automated correction verification can be performed by comparing the flagged credibility data against known business account information or other credibility data that has been matched to a particular business. Approved corrections are entered into the first database 430. Disapproved corrections are ignored.

In some embodiments, adjustments may be made to improve the matching accuracy of the matching algorithms in the matching algorithm database 340 based on the approved corrections. In this manner, the matching process 330 learns from prior mistakes and makes changes to the algorithms in a manner that improves the accuracy of future matches.

B. Database

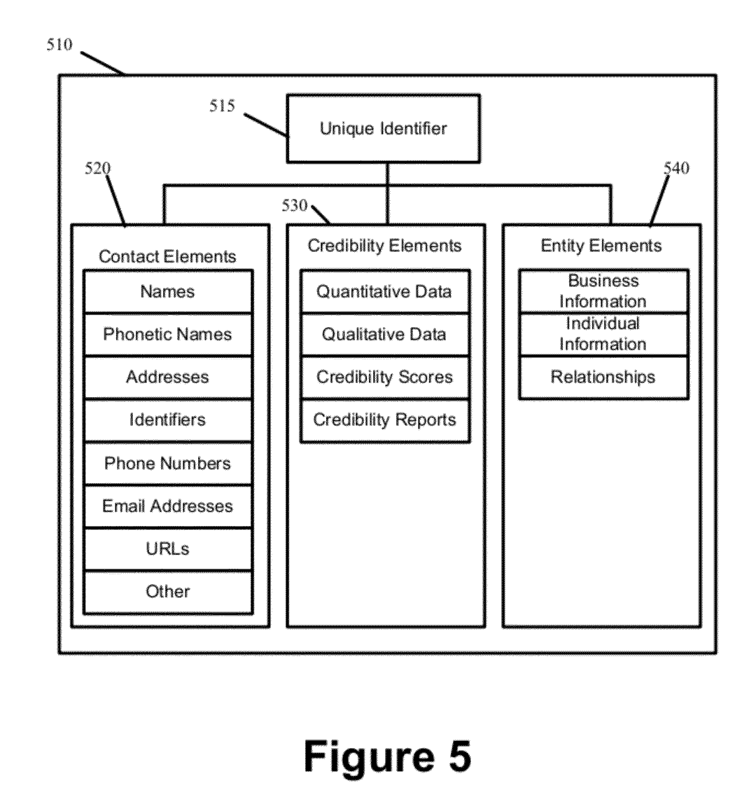

Referring back to FIG. 2, the database 220 stores various information pertaining to the credibility scoring of each particular business using the unique identifier that is assigned to that particular business. FIG. 5 illustrates an exemplary data structure 510 for storing the credibility scoring information. The data structure 510 includes unique identifier 515, contact elements 520, credibility elements 530, and entity elements 540.

As before, the unique identifier 515 uniquely identifies each business entity. The contact elements 520 store one or more names, addresses, identifiers, phone numbers, email addresses, and URLs that identify a business and that are used to match aggregated and tagged credibility data to a particular business. The credibility fields 530 store the aggregated and matched qualitative and quantitative credibility data. Additionally, the credibility fields 530 may store generated credibility scores and credibility reports that are linked to the unique identifier 515 of the data structure 510. The entity elements 540 specify business information, individual information, and relationship information. Business information may include business credit, financial information, suppliers, contractors, and other information provided by companies such as Dun & Bradstreet. Individual information identifies individuals associated with the business. Relationship information identifies the roles of the individuals in the business and the various business organization or structure. Individual information may be included to assist in the matching process and as factors that affect the credibility score. For example, executives with proven records of growing successful businesses can improve the credibility score for a particular business and inexperienced executives or executives that have led failing businesses could detrimentally affect the credibility score of the business.

Logically, the database 220 may include the databases 430 and 440 of FIG. 4 and other databases referred to in the figures and in this document. Physically, the database 220 may include one or more physical storage servers that are located at a single physical location or are distributed across various geographic regions. The storage servers include one or more processors, network interfaces for networked communications, and volatile and/or nonvolatile computer readable storage mediums, such as Random Access Memory (RAM), solid state disk drives, or magnetic disk drives.

C. Reporting Engine

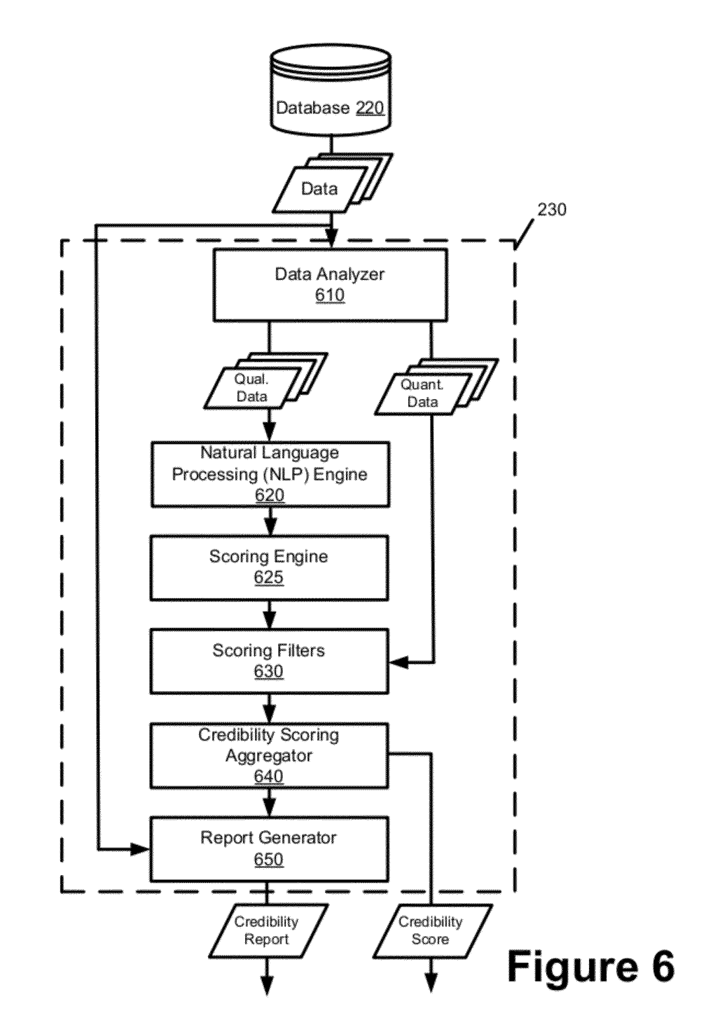

The reporting engine 230 accesses the database 220 to obtain credibility data from which to derive the credibility scores and credibility reports for various businesses. In some embodiments, the reporting engine 230 updates previously generated scores and reports when credibility scores and reports for a business have been previously generated and credibility data has changed or new credibility data is available in the database 220. FIG. 6 illustrates some components of the reporting engine 230 for generating credibility scores and credibility reports in accordance with some embodiments. The reporting engine 230 includes data analyzer 610, natural language processing (NLP) engine 620, scoring engine 625, scoring filters 630, credibility scoring aggregator 640, and report generator 650. In some embodiments, the reporting engine 230 and its various components 610-650 are implemented as a set of scripts or machine implemented processes that execute sets of computer instructions.

i. Data Analyzer

The data analyzer 610 interfaces with the database 220 in order to obtain aggregated credibility data for one or more businesses. As noted above, credibility data for a particular business is stored to the database 220 using a unique identifier. Accordingly, the data analyzer 610 is provided with one or a list of unique identifiers for which credibility scores and reports are to be generated. The list of unique identifiers may be provided by a system administrator or may be generated on-the-fly based on requests that are submitted through the interface portal. The data analyzer 610 uses the unique identifiers to retrieve the associated data from the database 220.

Once credibility data for a particular business is retrieved from the database 220, the data analyzer 610 analyzes that credibility data to identify qualitative credibility data from quantitative credibility data. As earlier noted, credibility data may include both qualitative and quantitative credibility data. In such cases, the data analyzer 610 segments the credibility data to separate the qualitative data portions from the quantitative data portions.

The data analyzer 610 uses pattern matching techniques and character analysis to differentiate the qualitative credibility data from the quantitative credibility data. Qualitative credibility data includes data that is not described in terms of quantities, not numerically measured, or is subjective. Text based reviews and comments obtained from sites such as www.yelp.com and www.citysearch.com are examples of qualitative data. Accordingly, the data analyzer 610 identifies such text based reviews and classifies them as qualitative credibility data. The data analyzer 610 passes identified qualitative data to the NLP engine 620 and the scoring engine 625 for conversion into quantitative measures.

Conversely, quantitative data includes data that is described in terms of quantities, is quantifiably measured, or is objective. A business credit score, rating, or rankings that are confined to a bounded scale (0-5 stars) are examples of quantitative data. Accordingly, the data analyzer 610 identifies these scores, ratings, and rankings as quantitative credibility data. The data analyzer 610 passes identified quantitative data to the scoring filters 630.

ii. NLP Engine

In some embodiments, the NLP engine 620 performs relationship identification on qualitative credibility data. Specifically, the NLP engine 620 identifies relationships between (i) textual quantifiers and (ii) modified objects.

In some embodiments, a textual quantifier includes adjectives or other words, phrases, and symbols from which quantitative measures can be derived. This includes words, phrases, or symbols that connote some degree of positivity or negativity. The following set of words connotes similar meaning albeit with different degrees: “good”, “very good”, “great”, “excellent”, and “best ever”. Textual quantifiers also include adjectives for which different degree equivalents may or may not exist, such as: “helpful”, “knowledgeable”, “respectful”, “courteous”, “expensive”, “broken”, and “forgetful”. The above listings are an exemplary set of textual quantifiers and are not intended to be an exhaustive listing. A full listing of textual quantifiers are stored to a database that is accessed by the NLP engine 620. In this manner, the NLP engine 620 can scale to identify new and different textual quantifiers as needed.

In some embodiments, a modified object includes words, phrases, or symbols that pertain to some aspect of a business and that are modified by one or more textual quantifiers. In other words, the modified objects provide context to the textual quantifiers. For example, the statement “my overall experience at the Acme Store was good, but the service was bad” contains two textual quantifiers “good” and “bad” and two modified objects “overall experience” and “service”. The first modified object “overall experience” is modified by the textual quantifier “good”. The second modified object “service” is modified by the textual quantifier “bad”. In some embodiments, a full listing of modified objects is stored in a database that is accessed by the NLP engine. Additionally, grammatical rules and other modified object identification rules may be stored to the database and used by the NLP engine to identify the objects that are modified by various textual quantifiers.

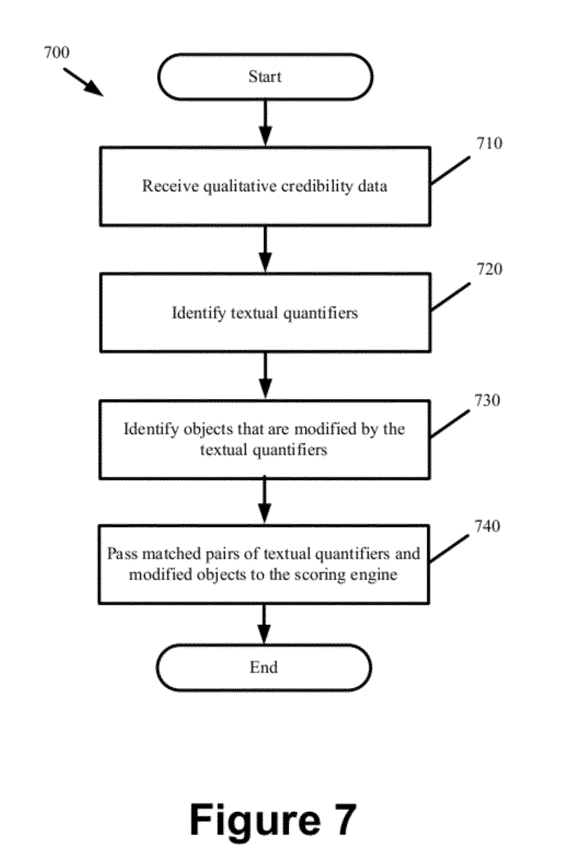

FIG. 7 presents a process 700 performed by the NLP engine 620 for identifying relationships between textual quantifiers and modified objects in accordance with some embodiments. The process 700 begins when the NLP engine 620 receives (at 710) qualitative credibility data from the data analyzer 610. The process performs an initial pass through the credibility data to identify (at 720) the textual quantifiers therein. During a second pass through, the process attempts to identify (at 730) a modified object for each of the textual quantifiers. Unmatched textual quantifiers or textual quantifiers that match to an object that does not relate to some aspect of a business are discarded. Matched pairs are passed (at 740) to the scoring engine 625 for conversion into quantitative measures and the process 700 ends. It should be apparent that other natural language processing may be performed over the qualitative credibility data in order to facilitate the derivation of quantitative measures from such data and that other such processing may be utilized by the NLP engine 620.

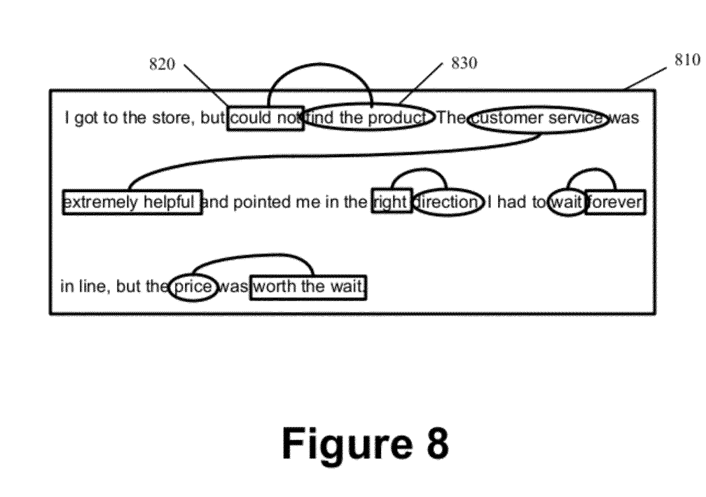

FIG. 8 illustrates identifying textual quantifier and modified object pairs in accordance with some embodiments. The figure illustrates qualitative credibility data 810 in the form of a business review. The review textually describes various user experiences at a business. When passed to the NLP engine 620 for processing, the textual quantifiers and modified objects of the credibility data are identified. In this figure, the textual quantifiers are indicated using the rectangular boxes (e.g., 820) and the modified objects (e.g., 830) are identified with circles.

iii. Scoring Engine

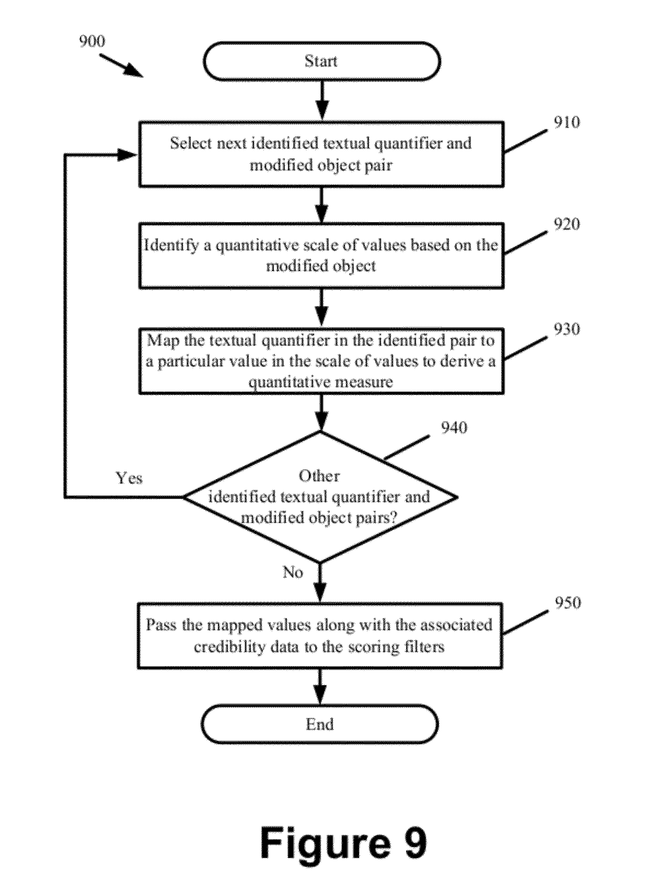

The NLP engine 620 passes the matched pairs of textual quantifiers and modified objects to the scoring engine 625. The scoring engine 625 converts each pair to a quantitative measure. FIG. 9 presents a process 900 for deriving quantitative measures from qualitative credibility data in accordance with some embodiments. The process 900 begins when the scoring engine 625 receives from the NLP engine 620 qualitative credibility data with identified pairs of textual quantifiers and modified objects.

The process selects (at 910) a first identified textual quantifier and modified object pair. Based on the modified object of the selected pair, the process identifies (at 920) a quantitative scale of values. In some embodiments, the scale of values determines a weight that is attributed to the particular modified object. Some modified objects are weighted more heavily than others in order to have greater impact on the credibility score. For example, from the statement “my overall experience at the Acme Store was good, but the service was bad”, the modified object “overall experience” is weighted more heavily than the modified object “service”, because “service” relates to one aspect of the business' credibility, whereas “overall experience” relates to the business credibility as a whole. In some embodiments, the process uses the modified object as an index or hash into a table that identifies the corresponding scale of values associated with that modified object.

Next, the process maps (at 930) the textual quantifier from the identified pair to a particular value in the identified scale of values to derive a quantitative measure. In some embodiments, the mapping is performed in conjunction with a conversion formula that outputs a particular value when the textual quantifier and a scale of values are provided as inputs. In some other embodiments, the textual quantifier maps to a first value that is then adjusted according to the scale of values identified by the modified object. For example, the textual quantifiers “good”, “very good”, “great”, “excellent”, and “best ever” map to values of 6, 7, 8, 9, and 10 respectively in an unadjusted scale of 0-10. A modified object that is paired with the textual quantifier “great” may identify a scale of value ranging from 0-100. Accordingly, the value associated with the textual quantifier (i.e., 8) is adjusted per the identified scale to a value of 80.

The process determines (at 940) whether there are other identified textual quantifier and modified object pairs associated with the credibility data. If so, the process reverts to step 910 and selects the next pair. Otherwise, the process passes (at 950) the mapped values along with the associated credibility data to the scoring filters 630 and the process 900 ends.

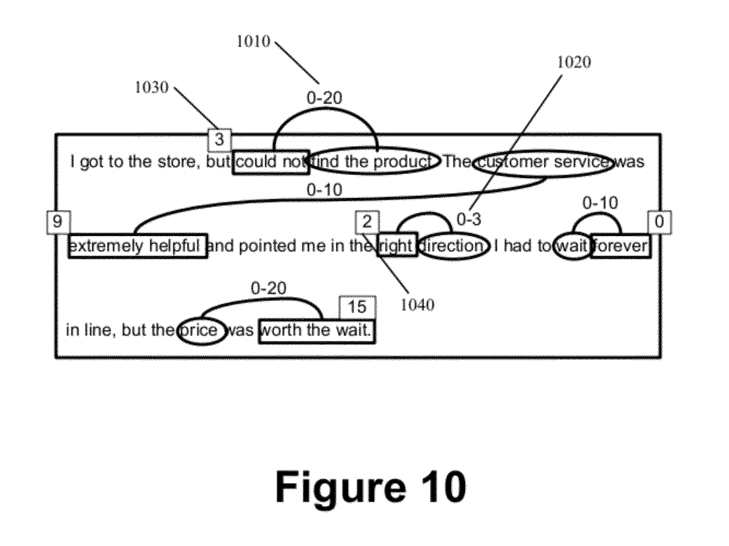

FIG. 10 illustrates mapping matched textual quantifier and modified object pairs to a particular value in a scale of values in accordance with some embodiments. As shown, for each identified textual quantifier and modified object pair, a scale of values (e.g., 1010 and 1020) is identified to represent the relative weight or importance of that modified object to the overall credibility score. For example, the scale of values 1010 ranges from 0-20 and the range of values 1020 ranges from 0-3. This indicates that the modified object that is associated with the scale of values 1010 is weighted more heavily in the credibility score than the modified object that is associated with the scale of values 1020. The textual quantifier for each identified pair is then mapped to a particular value in the scale of values (e.g., 1030 and 1040). In light of the present description, it should be apparent that the presented scales are for exemplary purposes and that the scoring engine 625 may utilize different scales for different modified objects.

In some embodiments, the reporting engine 230 monitors relationships between quantitative data and qualitative data to promote self-learning and adaptive scoring. Credibility data sources often provide a quantitative score that ranks or rates a business on some quantitative scale (e.g., 0-5 stars) and an associated set of qualitative data that comments on or explains the quantitative score. Based on the relationship between the quantitative data and the qualitative data, the reporting engine 230 of some embodiments adaptively adjusts how quantitative measures are derived from qualitative data. Specifically, the reporting engine 230 adjusts (i) the scale of values provided to certain modified objects found in qualitative data and (ii) the value that is selected in a scale of values for a particular textual quantifier that is associated with a modified object. For example, when a quantitative score of 5 out of 5 appears 75% of the time with qualitative data that includes the textual quantifier “good” and a quantitative score of 3 out of 5 appears 80% of the time with qualitative data that includes the textual quantifier “fine”, then the reporting engine 230 learns from these relationships to increase the quantifiable value for the “good” textual quantifier and decrease the quantifiable value for the “fine” textual quantifier.

In some embodiments, the reporting engine 230 monitors relationships between the various textual quantifiers and modified objects in the qualitative data to promote self-learning and adaptive scoring. Specifically, the reporting engine 230 adjusts the scale of values associated with a particular modified object based on the frequency with which that modified object appears in the qualitative data. Similarly, the reporting engine 230 can adjust the selected value associated with a particular textual quantifier based on the frequency with which that textual quantifier appears in the qualitative data. These frequency measurement can be made on an individual business basis, on a business sub-classification (e.g., fast food restaurant, fine dining restaurant, and family restaurant), or on a field of business basis (e.g., restaurants, clothing stores, and electronic stores). For example, when the phrase “the food was” appears in 75% of user reviews that are associated with a particular business and the phrase “the waiter was” appears in 10% of user reviews that are associated with that particular business, then the reporting engine 230 can provide greater weight to the scale of values that is associated with the modified object “food” than the scale of values that is associated with the modified object “waiter”. In this manner, the credibility score derived from the qualitative data can better account for those factors that users frequently comment on while reducing the impact that other rarely mentioned factors have on the credibility score.

In summary, the scale of values for certain modified objects and the selected value from the scale of values for the associated textual quantifier can be adaptively adjusted based on the correspondence between quantitative data that is associated with qualitative data and based on the relative frequency that a particular textual quantifier or modified object is used with reference to a particular business, sub-classification of a business, or field-of-business.

iv. Scoring Filters

In some embodiments, the scoring filters 630 filter the quantitative measures and the credibility data before producing the credibility score. In some embodiments, the scoring filters 630 include executable processes that incorporate different pattern matching criteria to identify which quantitative measures or which credibility data to filter based on what conditions. Each scoring filter may be specific to one or more types of credibility data. As such, the scoring filters are selectively applied to the credibility data based on the type of credibility data.

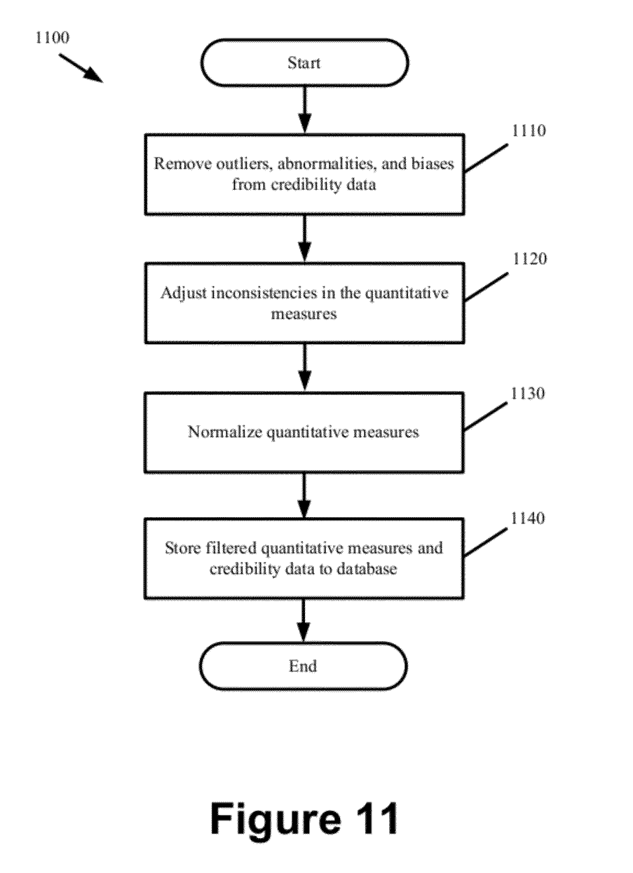

FIG. 11 presents a process 1100 performed by the scoring filters 630 to filter the quantitative measures and credibility data in accordance with some embodiments. The process begins by using a set of filters to remove (at 1110) quantitative measures obtained from outlying, abnormal, and biased credibility data. This includes removing quantitative measures that originate from credibility data that is irrelevant to the business at issue. For example, removing a quantitative measure that originates from credibility data that states various complaints with regards to difficulty in setting up equipment purchased from a store when setting up the equipment is unrelated to the goods and services offered by the store. Other filters may be defined to analyze credibility data in conjunction with information about the party submitting the review. For example, a filter may be defined that analyzes demographic information in association with credibility data. This is useful when a business is geared towards specific clientele and the party submitting the review does not fall into that classification of clientele. Accordingly, a scoring filter can be defined to remove such quantitative measures. Other quantitative measures from anonymous reviewers or credibility data that relates to extreme cases or irregular events can also be removed.

Next, the process uses a set of filters to adjust (at 1120) inconsistencies in the quantitative measures for the remaining credibility data. For example, different reviewers may each give a particular business a three out of five rating, but in the associated comments a first reviewer may provide positive feedback while a second reviewer may provide negative feedback. In such cases, filters can be defined to increase the quantitative measure provided by the first reviewer based on the positive feedback and decrease the quantitative measure provided by the second reviewer based on the negative feedback.

The process uses a set of filters to normalize (at 1130) the quantitative measures for the remaining credibility data. Normalization includes adjusting the scaling of quantitative measures. In some embodiments, the quantitative measures for qualitative credibility data that are derived by the scoring engine 625 will not require normalization. However, quantitative measures originating from quantitative credibility data may require normalization. For instance, quantitative measures of quantitative credibility data obtained from a first data source (e.g., www.yelp.com) may include a rating that is out of five stars and quantitative measures of quantitative credibility data obtained from a second data source (e.g., www.zagat.com) may include a point scale of 0-30 points. In some embodiments, the process normalizes these quantitative measures to a uniform scale of values (e.g., 0-100). In some other embodiments, the process normalizes these quantitative measures with disproportionate weighting such that quantitative measures obtained from credibility data of a more trusted data source are provided more weight than quantitative measures obtained from credibility data of a less trusted data source. Disproportionate weighting is also used to limit the impact stale credibility data has over the credibility score. Specifically, quantitative measures from older credibility data are normalized with less weighting than quantitative measure from newer credibility data. Different scoring filters may be defined to implement these and other weighting criteria.

The process stores (at 1140) the filtered quantitative measures data to the database 220 and the process ends. In some embodiments, the process directly passes the filtered quantitative measures to the credibility scoring aggregator 640 of the reporting engine 230.

v. Credibility Scoring Aggregator

The credibility scoring aggregator 640 produces a credibility score for a particular business based on normalized quantitative measures for that particular business. In some embodiments, the credibility score is a numerical value that is bounded in a range that represents a lack of credibility at one end and full credibility at another end, where credibility accounts for successes of various business practices, customer satisfaction, performance relative to competitors, growth potential, etc. In some embodiments, the credibility score may be encoded to specify different credibility aspects with different digits. For example, the first three digits of a six digit score specify a business credit score and the last three digits of the six digit score specify the credibility score. In some embodiments, the credibility score is a set of scores with each score representing a different component of credibility. For example, the credibility score may comprise a business credit score, a review score, and a rating score where the review score is compiled from quantitative measures derived from the aggregated qualitative data and the rating score is compiled from the normalized quantitative measures within the aggregated quantitative data. It should be apparent to one of ordinary skill in the art that the credibility score can be formatted in any number of other ways, such as a set of formatted characters or as a set of formatted alphanumeric characters.

To produce the credibility score, the credibility scoring aggregator 640 aggregates any filtered and normalized quantitative measures for a particular business from the database 220 or from the scoring filters 630. The credibility scoring aggregator 640 then uses one or more proprietary algorithms to factor together the quantitative measures to produce the credibility score. This may include averaging, summing, or using proprietary formulas to produce the credibility score from the aggregated set of quantitative measures. These algorithms allow for a credibility score to be computed with any number of available quantitative measures. The produced credibility score is then stored back to the database 220 where it is associated with the particular business.

From the interface portal 240 of FIG. 2, users and businesses can access and view their credibility score. In some embodiments, the credibility score is updated and presented in real-time. In some embodiments, the credibility score is a tangible asset that users and businesses purchase before provided access to the credibility score. Users and businesses can purchase a onetime viewing of the credibility score or can purchase a subscription plan that allows them to view their credibility score anytime during a particular subscription cycle (e.g., monthly, yearly, etc.). Users and businesses can purchase and view credibility reports that are associated with their businesses in order to understand their credibility or can purchase credibility scores for other businesses that they may be interested in doing business with or to see a competitor's credibility.

vi. Report Generator

The report generator 650 operates in conjunction with the credibility scoring aggregator 640. In some embodiments, the report generator 650 is tasked with producing reports that detail how a credibility score was derived, areas where a business has been successful, other areas that need improvement, standing relative to competitors, and suggested improvements that can be made to improve upon the credibility score. The credibility reports therefore provide complete transparency into how a credibility score is derived. From the credibility report, businesses can view and report on inaccurately associated credibility data, businesses can identify potential identity fraud or others that are free riding on the generated goodwill of the business, and businesses can proactively interact with and improve their credibility score and the individual components from which the score is derived. The generated report may be sold as a separate tangible asset from the credibility score. As before, users access the credibility reports through the interface portal 240, though some embodiments provide the credibility scores and credibility reports in other mediums such as in writing or by telephone consultation.

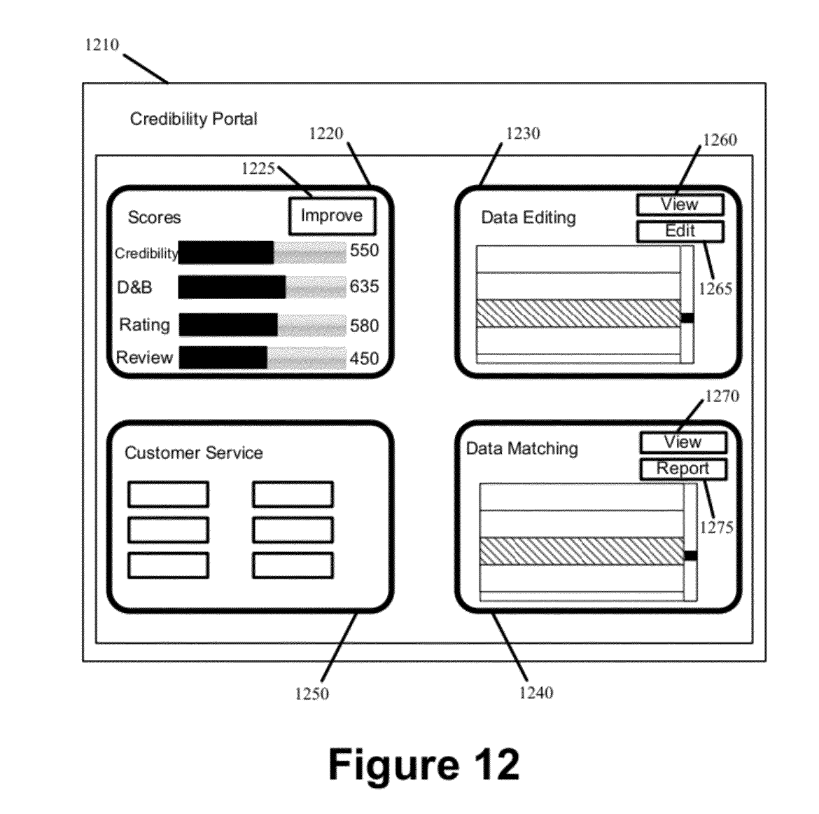

FIG. 12 illustrates a credibility report window 1210 within the interface portal 240 in accordance with some embodiments. As shown, the credibility report window 1210 includes multiple viewing panes 1220, 1230, 1240, and 1250 with various information and actions therein.

Pane 1220 is the scores pane that presents the credibility score and/or components of the credibility score such as the Dun & Bradstreet business credit score, credibility ranking score, and credibility review score. In some embodiments, the credibility score identifies the overall credibility of the business, while the ranking score is derived from normalized quantitative measures of quantitative data and review score is derived from quantitative measures obtained from processing qualitative data. In some embodiments, the scores are presented using indicator bars and/or numerical values. The indicator bars may be color coded to better differentiate the scores. For example, a red color indicates a poor score, a yellow color indicates a neutral score, and a green color indicates a good score. Also included within pane 1220 is button 1225. When the button 1225 is clicked, the report provides various suggestions as to how the user can improve upon the score, areas that need improvement, or areas that are currently successful. Such information can be presented in a pop-up dialog box or by changing the contents of the pane 1220.

Pane 1230 is the data editing pane. In this pane, users can either adjust a data review that was aggregated from a data source or provide new data that previously was not incorporated into the credibility score. This can include correcting errors in the aggregated data. Included in pane 1230 are buttons 1260 and 1265. Button 1260 allows for a specific entry within the pane 1230 to be expanded for editing. Button 1265 allows a user to submit new credibility data including data that is not available at the various aggregated data sources or new data that has not yet propagated to the data sources.

Pane 1240 is the data matching pane whereby user reviews and other aggregated credibility data can be viewed and mismatched data can be identified and reported. Specifically, the business owner can scroll through a list of aggregated quantitative and qualitative data to see what others are saying about the business. The includes viewing positive and negative feedback, suggestions for improving the business, issues experienced by users, what users like about the business, etc. Additionally, the pane 1240 includes buttons 1270 and 1275 for expanding a specific entry and for reporting an error. The error may include data that pertains to another business and that was improperly matched to the business for which the credibility report is generated. The error may also include data that should have been filtered out as biased data or as an anomaly. The pane 1240 may also present information about the business, such as addresses, agents, phone numbers, etc.

Pane 1250 is the customer service pane. In some embodiments, this pane provides summary information about the credibility score and report such as what the business is doing well and what areas need improvement. This pane can also provide suggested actions for the business as well contact information for users seeking additional support. In some embodiments, the pane 1250 provides an interactive chat window to a customer support representative.

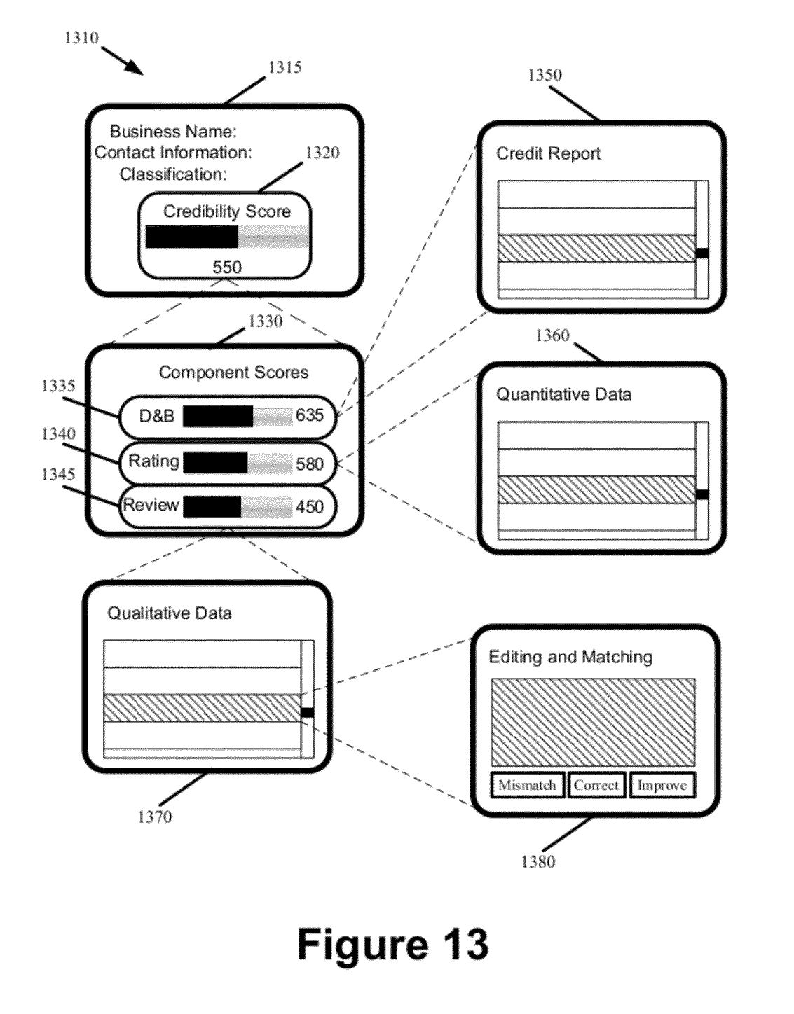

FIG. 13 presents an alternative credibility report viewer 1310 in accordance with some embodiments. The credibility report viewer 1310 provides a drill-down view for the credibility report whereby a user can obtain more detailed information about the credibility of a business at each drill-down layer. The credibility report viewer 1310 is displayed with a first layer 1315 that provides a cumulative credibility score 1320 for the business. The cumulative credibility score 1320 is a single numerical or alphanumeric value that quantifies the credibility of a business into a standardized score.

The user can click on the credibility score 1320 to drill-down to a second layer 1330. When the user clicks on the credibility score 1320, some embodiments change the display of the credibility report viewer 1310 from displaying contents of the first drill-down layer 1315 to displaying contents of the second drill-down layer 1330. Navigation functionality allows a user to return back to the first drill-down layer 1315 or any other layer at any time. Instead of changing the display of the credibility report viewer 1310, some embodiments provide a second window or display area to display the second drill down layer 1330.

The second drill-down layer 1330 presents various component scores from which the credibility score 1320 is derived. In some embodiments, the component scores include a first score 1335, a second score 1340, and a third score 1345. In some embodiments, the first score 1335 is a score that quantifies the credit worthiness of the business. The first score 1335 may therefore be a Dun and Bradstreet credit score or other similar business credit score. In some embodiments, the second score 1340 is a rating score that quantifies the quantitative data that was aggregated from the various data sources into a single score. In some embodiments, the third score 1345 is a review score that quantifies the qualitative data that was aggregated from the various data sources into a single score.

The user can drill-down further to view the data that was used to derive each of the component scores. Specifically, by clicking on the first score 1335, the user drills-down to a third layer 1350 that presents a Dun and Bradstreet or other similar business credit report. Alternatively, the user may be presented with a request window from which the user can purchase a Dun and Bradstreet or other similar business credit report. By clicking on the second score 1340, the user drills-down to a third layer 1360 that presents the various aggregated quantitative data used in deriving the rating score component of the credibility score 1320. Similarly, by clicking on the third score 1345, the user drills-down to a third layer 1370 that presents the various aggregated qualitative data used in deriving the review score component of the credibility score 1320.

The user can click on any business credit data, quantitative data, or qualitative data that is presented within the various third drill-down layers 1350-1370 in order to access another drill-down layer, such as layer 1380, that allows for users to correct errors and mismatched data, provide new data, or receive suggestions on how to improve upon the various credibility score components. Suggestions may be provided through another drill-down layer that provides an interactive chat window that connects to a credibility specialist or by providing guides on improving the various credibility score components. It should be apparent to one of ordinary skill in the art that any number of drill-down layers may be provided and that each layer may include additional or other information than those presented in FIG. 13.

III. Computer System

Many of the above-described processes and modules are implemented as software processes that are specified as a set of instructions recorded on a computer readable storage medium (also referred to as computer readable medium). When these instructions are executed by one or more computational element(s) (such as processors or other computational elements like ASICs and FPGAs), they cause the computational element(s) to perform the actions indicated in the instructions. Computer and computer system is meant in its broadest sense, and can include any electronic device with a processor including cellular telephones, smartphones, portable digital assistants, tablet devices, laptops, and netbooks. Examples of computer readable media include, but are not limited to, CD-ROMs, flash drives, RAM chips, hard drives, EPROMs, etc.

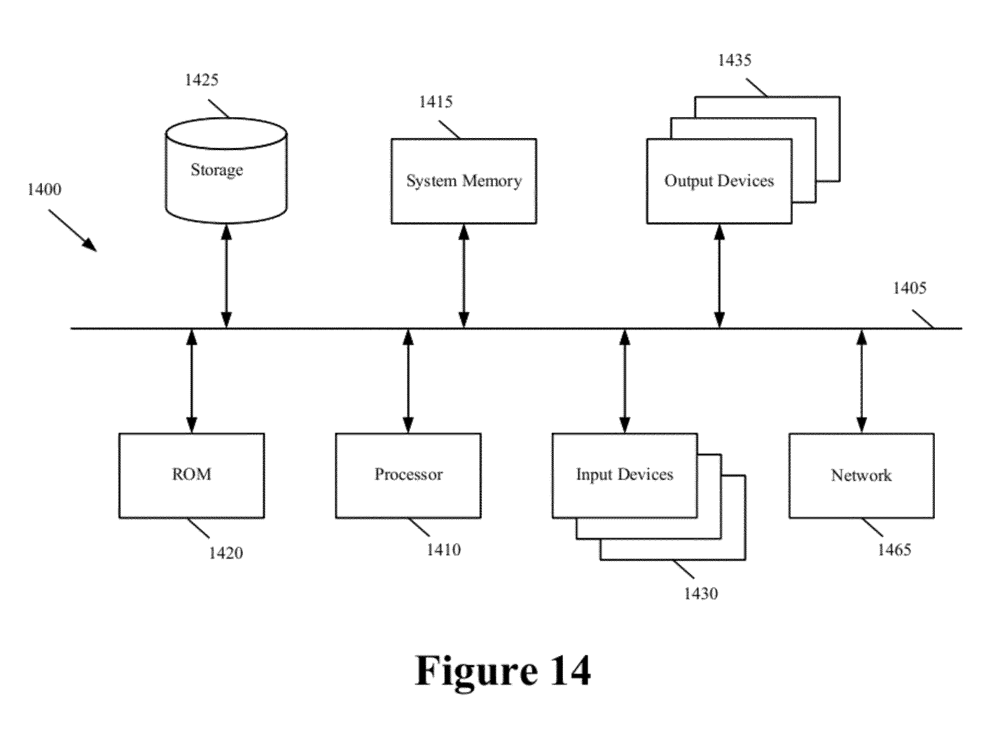

FIG. 14 illustrates a computer system with which some embodiments are implemented. Such a computer system includes various types of computer readable mediums and interfaces for various other types of computer readable mediums that implement the various processes, modules, and engines described above (e.g., master data management acquisition engine, reporting engine, interface portal, etc.). Computer system 1400 includes a bus 1405, a processor 1410, a system memory 1415, a read-only memory 1420, a permanent storage device 1425, input devices 1430, and output devices 1435.

The bus 1405 collectively represents all system, peripheral, and chipset buses that communicatively connect the numerous internal devices of the computer system 1400. For instance, the bus 1405 communicatively connects the processor 1410 with the read-only memory 1420, the system memory 1415, and the permanent storage device 1425. From these various memory units, the processor 1410 retrieves instructions to execute and data to process in order to execute the processes of the invention. The processor 1410 is a processing device such as a central processing unit, integrated circuit, graphical processing unit, etc.

The read-only-memory (ROM) 1420 stores static data and instructions that are needed by the processor 1410 and other modules of the computer system. The permanent storage device 1425, on the other hand, is a read-and-write memory device. This device is a non-volatile memory unit that stores instructions and data even when the computer system 1400 is off. Some embodiments of the invention use a mass-storage device (such as a magnetic or optical disk and its corresponding disk drive) as the permanent storage device 1425.

Other embodiments use a removable storage device (such as a flash drive) as the permanent storage device Like the permanent storage device 1425, the system memory 1415 is a read-and-write memory device. However, unlike storage device 1425, the system memory is a volatile read-and-write memory, such a random access memory (RAM). The system memory stores some of the instructions and data that the processor needs at runtime. In some embodiments, the processes are stored in the system memory 1415, the permanent storage device 1425, and/or the read-only memory 1420.

The bus 1405 also connects to the input and output devices 1430 and 1435. The input devices enable the user to communicate information and select commands to the computer system. The input devices 1430 include any of a capacitive touchscreen, resistive touchscreen, any other touchscreen technology, a trackpad that is part of the computing system 1400 or attached as a peripheral, a set of touch sensitive buttons or touch sensitive keys that are used to provide inputs to the computing system 1400, or any other touch sensing hardware that detects multiple touches and that is coupled to the computing system 1400 or is attached as a peripheral. The input device 1430 also include alphanumeric keypads (including physical keyboards and touchscreen keyboards), pointing devices (also called “cursor control devices”). The input devices 1430 also include audio input devices (e.g., microphones, MIDI musical instruments, etc.). The output devices 1435 display images generated by the computer system. For instance, these devices display the KEI. The output devices include printers and display devices, such as cathode ray tubes (CRT) or liquid crystal displays (LCD).

Finally, as shown in FIG. 14, bus 1405 also couples computer 1400 to a network 1465 through a network adapter (not shown). In this manner, the computer can be a part of a network of computers (such as a local area network (“LAN”), a wide area network (“WAN”), or an Intranet, or a network of networks, such as the internet. For example, the computer 1400 may be coupled to a web server (network 1465) so that a web browser executing on the computer 1400 can interact with the web server as a user interacts with a GUI that operates in the web browser.

As mentioned above, the computer system 1400 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1.-22. (canceled)

23. A method for producing a report for identifying credibility data affecting credibility of a particular entity, the method comprising:
aggregating from a plurality of data sources credibility data that comprises (i) qualitative data having textual reviews that are directed to the particular entity and (ii) quantitative data having quantitative measures for quantifiably rating the particular entity;
ordering said qualitative data and said quantitative data into a plurality of groups, wherein each group of the plurality of groups representing a different component for credibility of the particular entity;
deriving a credibility score for the particular entity to represent credibility for the particular entity as collectively expressed by the textual reviews of the qualitative data and the quantitative measures of the quantitative data ordered to each group of the plurality of groups; and
producing a report comprising said credibility score and a set of hierarchical drill-down layers for presenting each subset of said qualitative data and said quantitative data that is ordered to each group of the plurality of groups.

24. The method of claim 23, wherein the set of hierarchical drill-down layers comprises a first layer and a second layer, wherein the second layer comprises at least one of qualitative data and quantitative data that enhances qualitative data and quantitative data that is presented in the first layer.

25. The method of claim 24 further comprising providing at least one interactive tool for accessing the at least one of qualitative data and quantitative data of the second layer from the first layer.

26. The method of claim 24 further comprising providing an interface for presenting said credibility score and for interacting with the credibility score to access subsets of qualitative data and quantitative data that are associated with each group of the plurality of groups.

27. The method of claim 23, wherein the plurality of groups comprises a first group and a second group, wherein first group comprises the quantitative data and the second group comprises the qualitative data.

28. The method of claim 27 further comprising deriving a rating score to quantifiably represent a first component of credibility for the particular entity as collectively expressed by the quantitative measures of the quantitative data and a review score to quantifiably represent a second component of credibility for the particular entity as collectively expressed by the textual reviews of the qualitative data.

29. The method of claim 28, wherein producing the report further comprises presenting the rating score and the review score.

30. The method of claim 29, wherein the rating score is associated with a first drill-down layer for presenting the rating score and a second drill-down layer for presenting quantitative measures from a subset of the aggregated quantitative data used in deriving the rating score, and wherein the review score is associated with a first drill-down layer for presenting the review score and a second drill-down layer for presenting textual reviews from a subset of the aggregated qualitative data used in deriving the review score.

31. The method of claim 29, wherein the credibility score is associated with a first drill-down layer for presenting the credibility score and a second drill-down layer for presenting the review score and the rating score.

32. The method of claim 23, wherein the particular entity is a business entity.

33. The method of claim 23 further comprising storing said report to a database for subsequent viewing of the credibility of said particular entity.

34. A method for producing a report for identifying credibility data affecting credibility of a particular entity, the method comprising:
aggregating from a plurality of data sources credibility data that comprises (i) qualitative data comprising reviews and critiques of the particular entity and (ii) quantitative data comprising quantitative measures related to credibility of the particular entity;
grouping said aggregated data to a relevant component of credibility from a plurality of components of credibility;
ordering data that is grouped to a relevant component of credibility to at least a first drill-down layer and a second drill-down layer;
providing interactions that are associated with at least one data ordered to a first drill-down layer, wherein said interactions are usable to access data ordered to a second drill-down layer that is associated with said first drill-down layer; and
producing a report for interactively presenting credibility for said particular entity based on said aggregated, grouped, and ordered data and said interactions.

35. The method of claim 34 further comprising providing an interface for at least one of the particular entity and another entity to submit credibility data for inclusion in said report.

36. The method of claim 35, wherein the interface is further for the particular entity to identify at least one of quantitative data and qualitative data that is improperly aggregated for the particular entity.

37. The method of claim 34 further comprising providing access to said report to entities that have paid an access fee.

38. The method of claim 34 further comprising providing an interface for entities to purchase access to said report.

39. A graphical user interface (GUI) comprising:
a first interface for identifying a particular business entity;
a second interface accessible from the first interface for presenting a score that quantifiably identifies credibility of the particular business entity according to a standardized scoring scale used in identifying credibility for a plurality of business entities; and
an interactive tool for expanding the second interface to present at least a first viewable component group of credibility data used in deriving said score and a second viewable component group of credibility data used in deriving said score.

40. The GUI of claim 39, wherein the interactive tool is for interacting with the score to expand said score into a set of component scores, wherein each component score of the plurality of component scores presents a different score representing a different component for credibility of the particular business entity.

41. The GUI of claim 39, wherein the interactive tool is for interacting with the score to expand said score in a set of component scores, wherein a first component score of the set of component scores is a rating score that represents a first component of credibility for the particular business entity as collectively expressed by quantitative measures that are aggregated from a plurality of data sources, and wherein a second component score of the set of components scores is a review score that represents a second component of credibility for the particular business entity as collectively express by textual reviews that are directed to the particular business entity and that are aggregated from a plurality of data sources.

42. The GUI of claim 39, wherein the first viewable component group comprises a plurality of quantitative measures from a plurality of entities that quantifiably rate transacting with the particular entity and the second viewable component group comprises a plurality of textual reviews from a plurality of entities that are directed to the business entity.
